(19) United States
(12) Patent Application Publication
(10) Pub. No.: US 2012/0237205 A1
(43) Pub. Date: Sep. 20, 2012

(54) SYSTEM AND METHOD TO COMPENSATE FOR ARBITRARY OPTICAL FIBER LEAD-INS IN AN OPTICAL FREQUENCY DOMAIN REFLECTOMETRY SYSTEM

(75) Inventors: Roger G. Duncan, Christiansburg, VA (US); Alexander M. Barry, Roanoke, VA (US); Brooks A. Childers, Christiansburg, VA (US); Ajit Balagopal, Christiansburg, VA (US); Philip Robin Couch, Devon (GB)

(73) Assignee: BAKER HUGHES INCORPORATED, Houston, TX (US)

(21) Appl. No.: 13/049,357

(22) Filed: Mar. 16, 2011

(51) Int. Cl. H04B 10/08

(52) U.S. Cl. 398/25

(57) ABSTRACT

A method for estimating a parameter includes: generating an optical signal, the optical signal modulated via a modulation signal having a variable modulation frequency over a period of time; transmitting the modulated optical signal from a light source into an optical fiber, the optical fiber including at least one sensing location configured to reflect light; receiving a reflected signal including light reflected from the at least one sensing location; and demodulating the reflected signal with a reference signal, the reference signal including a time delay relative to the modulation signal based on a distance between the light source and the at least one sensing location.

### BACKGROUND

Fiber-optic sensors have been utilized in a number of applications, and have been shown to have particular utility in sensing parameters in various environments. Optical fiber sensors can be incorporated into environments such as downhole environments and be used to sense various parameters of an environment and/or the components disposed therein, such as temperature, pressure, strain and vibration.

Parameter monitoring systems can be incorporated with downhole components as fiber-optic distributed sensing systems (DSS). Examples of DSS techniques include Optical Frequency Domain Reflectometry (OFDR), which includes interrogating an optical fiber sensor with an optical signal to generate reflected signals scattered from sensing locations (e.g., fiber Bragg gratings) in the optical fiber sensor.

Many downhole applications typically require measuring parameters at extremely long depths, which are further extended in marine applications. Lead-in lengths (i.e., the length of the optical fiber from an optical interrogator to the region of interest) can thus be quite long, which can reduce the effective measurement range of DSS systems.

### SUMMARY

A method for estimating a parameter includes: generating an optical signal, the optical signal modulated via a modulation signal having a variable modulation frequency over a period of time; transmitting the modulated optical signal from a light source into an optical fiber, the optical fiber including at least one sensing location configured to reflect light; receiving a reflected signal including light reflected from the at least one sensing location; and demodulating the reflected signal with a reference signal, the reference signal including a time delay relative to the modulation signal based on a distance between the light source and the at least one sensing location.

A system for estimating a parameter includes: a light source in optical communication with an optical fiber, the optical fiber including at least one sensing location configured to reflect light; a modulator configured to modulate the optical signal via a modulation signal having a variable modulation frequency over a period of time; a detector configured to receive a reflected signal including light reflected from the at least one sensing location; and a processor configured to demodulate the reflected signal with a reference signal, the reference signal including a time delay based on a distance between the light source and the at least one sensing location.

A computer-readable medium includes computer-executable instructions for estimating a parameter by implementing a method including: generating an optical signal, the optical signal modulated via a modulation signal having a variable modulation frequency over a period of time; transmitting the modulated optical signal from a light source into an optical fiber, the optical fiber including at least one sensing location configured to reflect light; receiving a reflected signal including light reflected from the at least one sensing location; and demodulating the reflected signal with a reference signal, the reference signal including a time delay relative to the modulation signal based on a distance between the light source and the at least one sensing location.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings, wherein like elements are numbered alike, in which:

FIG. 1 illustrates an exemplary embodiment of a downhole drilling, monitoring, evaluation, exploration and/or production system;

FIG. 2 illustrates an exemplary embodiment of a measurement unit of the system of FIG. 1;

FIG. 3 is a flow chart illustrating an exemplary embodiment of a method of estimating a parameter;

FIG. 4 is an illustration of a modulation frequency of a modulated optical signal;

FIG. 5 is an illustration of the modulated optical signal of FIG. 4;

FIG. 6 is an illustration of exemplary reflected signals returned from an optical fiber in response to a modulated optical signal;

FIG. 7 is an illustration of a modulation frequency of a demodulation signal, the demodulation signal being temporally delayed relative to the modulated optical signal of FIGS. 4 and 5; and

FIG. 8 is an illustration of exemplary return signal data generated according to the method of FIG. 3.

### DETAILED DESCRIPTION

There are provided systems and methods for interrogating one or more optical fibers. An exemplary method includes generating an optical signal and modulating the optical signal by a modulation signal having a modulation frequency. The modulation frequency may be substantially constant or may be varied over a selected time period. For example, the modulation signal frequency is varied in a step-wise manner or chirped over the time period. This modulated optical signal is launched by an interrogator into an optical fiber having a sensing region that includes one or more measurement locations. An oscillating reference signal is generated and a delay is introduced into the reference signal to compensate for distances of the optical fiber between the interrogator and the sensing region, for example by introducing a delay to the modulation signal after the modulated optical signal is launched or by generating a second delayed modulation signal. A reflected and/or backscattered optical signal is received and then combined (e.g., mixed or demodulated) with the delayed reference signal to output a signal indicative of the difference in frequency between the modulation signal and the backscattered signal. This frequency difference is analyzed to estimate parameters of the optical fiber sensing region.

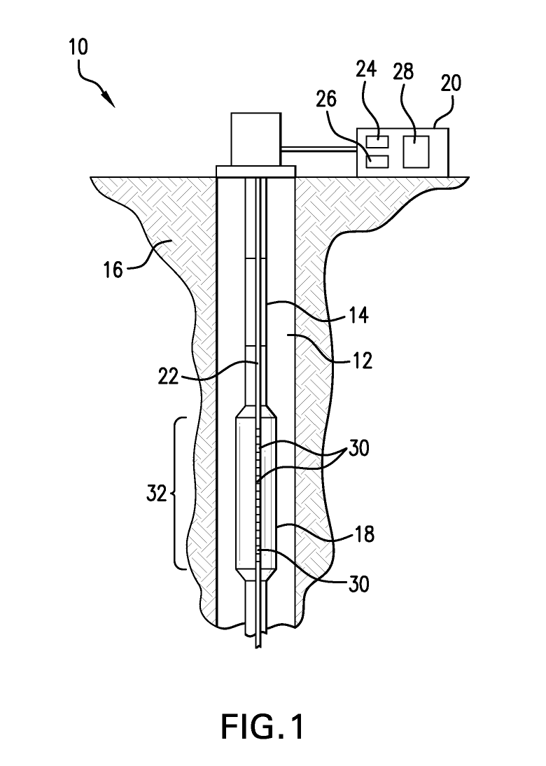

Referring to FIG. 1, an exemplary embodiment of a downhole drilling, monitoring, evaluation, exploration and/or production system 10 disposed in a wellbore 12 is shown. A borehole string 14 is disposed in the wellbore 12, which penetrates at least one earth formation 16 for performing functions such as extracting matter from the formation and/or making measurements of properties of the formation 16 and/or the wellbore 12 downhole. The borehole string 14 is made from, for example, a pipe, multiple pipe sections or flexible tubing. The borehole string 14 includes for example, a drilling system and/or a bottomhole assembly (BHA). The system 10 and/or the borehole string 14 include any number of downhole tools 18 for various processes including drilling, hydrocarbon production, and formation evaluation (FE) for measuring one or more physical quantities in or around a borehole. Various measurement tools 18 may be incorporated into the system 10 to affect measurement regimes such as wireline measurement applications or logging-while-drilling (LWD) applications.

In one embodiment, a parameter measurement system is included as part of the system 10 and is configured to measure or estimate various downhole parameters of the formation 16, the borehole 14, the tool 18 and/or other downhole components. The measurement system includes an optical interrogator or measurement unit 20 connected in operable communication with at least one optical fiber 22. The measurement unit 20 may be located, for example, at a surface location, a subsea location and/or a surface location on a marine well platform or a marine craft. The measurement unit 20 may also be incorporated with the borehole string 12 or tool 18, or otherwise disposed downhole as desired. The measurement unit 20 includes, for example, an electromagnetic signal source 24 such as a tunable light source, a LED and/or a laser, and a signal detector 26. In one embodiment, a processing unit 28 is in operable communication with the signal source 24 and the detector 26 and is configured to control the source 24, receive reflected signal data from the detector 26 and/or process reflected signal data. Although the measurement system is described herein as part of a downhole system, it is not so limited. The measurement system may be used in conjunction with any surface or downhole environment, particularly those that would benefit from distributed parameter (e.g., temperature or pressure) measurements.

The optical fiber 22 is operably connected to the measurement unit 20 and is configured to be disposed downhole. The optical fiber 22 includes one or more sensing locations 30 disposed along a length of the optical fiber. The sensing locations 30 are configured to reflect and/or scatter optical interrogation signals transmitted by the measurement unit 20. Examples of sensing locations include fiber Bragg gratings (FBG), mirrors, Fabry-Perot cavities and locations of intrinsic scattering. Locations of intrinsic scattering include points in or lengths of the fiber that reflect interrogation signals, such as Rayleigh scattering, Brillouin scattering and Raman scattering locations. The sensing locations 30 are configured to return reflected and/or backscattered signals (referred to herein collectively as “reflected signals”) from the sensing locations 30 in response to optical measurement signals (i.e., interrogation signals) launched into the optical fiber 22. The optical fiber 22 also includes a sensing region 32, i.e., any length of the optical fiber 22 along which parameter measurements are desired to be taken. For example, the sensing region 32 is a length of the optical fiber 22 that is disposed with the tool 18 and can be used to measure parameters such as temperature and deformation of the tool 18. In another example, the sensing region 32 is configured for distributed temperature sensing and extends along the entire length of the optical fiber 22 that is disposed downhole.

In one embodiment, the measurement system is configured as an optical frequency-domain reflectometry (OFDR) system. In this embodiment, the source 24 includes a continuously tunable laser that is used to spectrally interrogate the optical fiber sensor 22. Scattered signals reflected from intrinsic scattering locations, sensing locations 30 and other reflecting surfaces in the optical fiber 22 may be detected, demodulated, and analyzed. Each scattered signal can be correlated with a location by, for example, a mathematical transform or interferometrically analyzing the scattered signals in comparison with a selected common reflection location. Each scattered signal can be integrated to reconstruct the total length and/or shape of the cable.

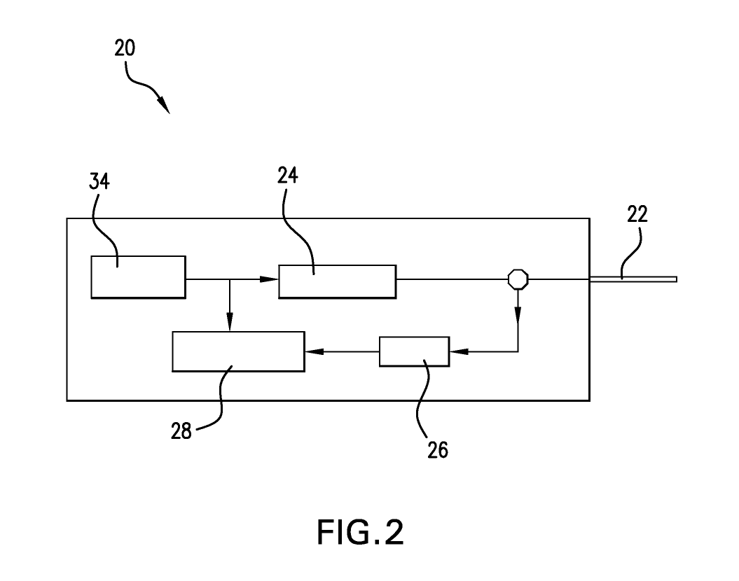

An example of the measurement unit 20 is shown in FIG. 2. In this example, the measurement unit is an OFDR device. The measurement unit 20 includes the optical source 24, such as a continuous wave (cw) frequency (or wavelength) tunable diode laser optically connected to the optical fiber 22. A modulator (e.g., function generator) 34 in optical communication with the tunable optical source 24 modulates the optical source 24, such as by power, intensity or amplitude, using a modulation signal. The modulation signal is generally an oscillating waveform, such as a sine wave, having a modulation frequency. In one embodiment, the modulator 34 may be incorporated as part of the optical source 24. A detector 26, such as a photodiode, is included to detect reflected signals from the optical fiber 22 in response to modulated optical signal launched from the optical source 24.

Still referring to FIG. 2, a computer processing system 28 is coupled to at least the detector 26, and is configured to process the reflected light signals. For example, the computer processing system 28 can demodulate the reflected signal using a demodulation signal, such as the modulation signal used in launching the optical interrogation signal. The computer processing system can be configured as a signal mixer, which measures the amplitude and phase of the modulation signal with respect to a received reflected signal. The processing system 28 may also be configured to further process the demodulated signal. For example, the processing system 28 is configured to transform the reflected signal to allow spatial correlation of the signal with the sensing locations 30, such as by performing a fast Fourier transform (FFT) on the reflected signals. The computer processing system 28 can be standalone or incorporated into the measurement unit 20. Various additional components may also be included as part of the measurement unit 20, such as a spectrum analyzer, beam splitter, light circulator, gain meter, phase meter, lens, filter and fiber optic coupler for example.

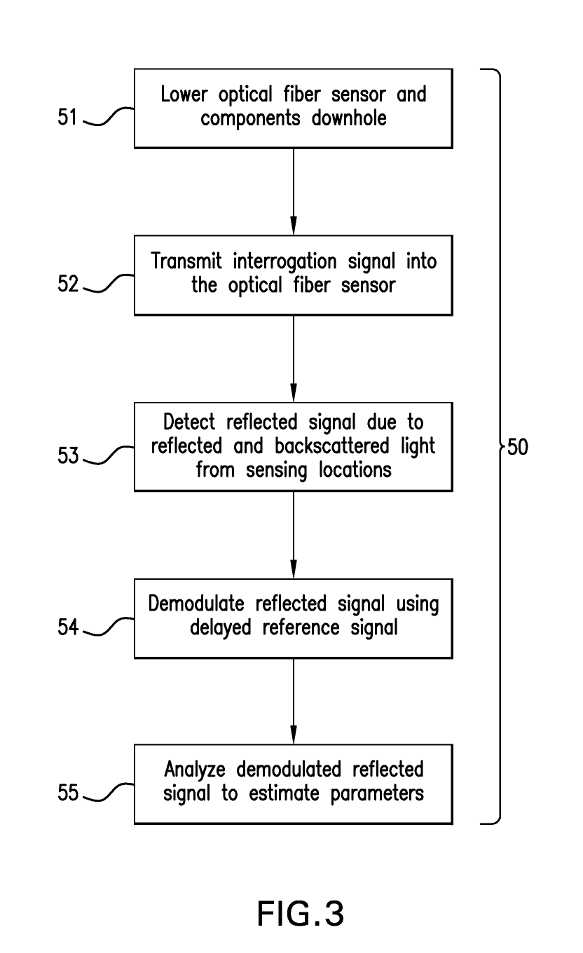

FIG. 3 illustrates a method 50 of measuring downhole parameters. The method 50 includes one or more stages 51-55. Although the method 50 is described in conjunction with the system 10 and the measurement system described above, the method 50 is not limited to use with these embodiments, and may be performed by the measurement unit 20 or other processing and/or signal detection device. In one embodiment, the method 50 includes the execution of all of stages 51-55 in the order described. However, certain stages may be omitted, stages may be added, or the order of the stages changed.

In the first stage 51, the optical fiber 22 along with the borehole string 12, tools 18 and/or other components are lowered downhole. The components may be lowered via, for example, a wireline or a drillstring.

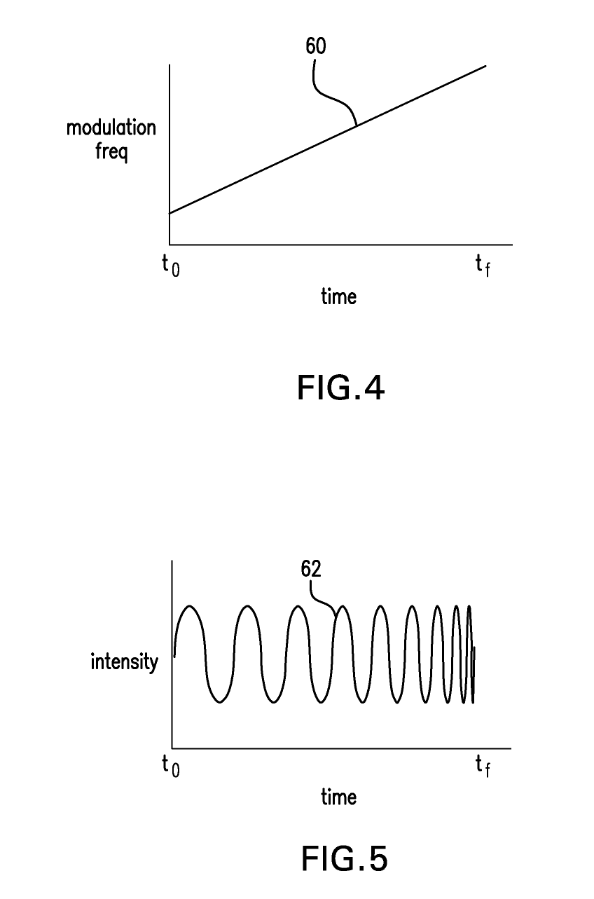

In the second stage 52, a modulated optical signal is generated and launched into the optical fiber 22. The modulator 34 modulates the power, intensity and/or amplitude of the optical signal according to a sinusoidal or other oscillating function having a time-varying oscillation frequency, also referred to as a “modulation frequency”. In general, the modulation frequencies are in the radio frequency range, although other frequencies can be used down to zero Hertz. The frequency of modulation is swept, i.e., changed, by the modulator 34 over a period of time, such as in a step-wise change, a continuous or nearly continuous change (e.g., linear change, exponential). For example, the modulator 34 modulates the optical signal with a modulation signal having a modulation frequency represented by a linear function 60 shown in FIG. 4. The function begins at an initial time “t₀”, at which the modulation frequency is at a selected minimum (e.g., at or near zero), and ends at a time “t_{f}”, at which the modulation frequency is a selected maximum. FIG. 5 is an illustration of a corresponding optical signal 62 as modulated according to the modulation frequency function 60 of FIG. 4. Multiple modulated signals may be iteratively launched for multiple laser wavelengths.

One non-limiting example of changing the modulation frequency is a step-wise change. Hence, the received light (i.e., signals) can be considered to be in response to a step input. The difference between frequency-steps for step-wise changes can be constant or varied. The resolution of the measurements of the components can be increased by decreasing the difference between the frequency-steps. The difference between the frequency-steps can be selected manually or automatically. In one embodiment, the difference is constant and predetermined. In another embodiment, the difference can be automatically selected during the measurement process such that a coarse scan can be performed and then followed up with a finer resolution scan if, for example, some aspect of the measurement is perceived to have changed.

In the third stage 53, a reflected signal is detected by the detector 26 and corresponding reflected signal data is generated by the processor 26. The reflected signals may include light reflected and/or backscattered from sensing locations 30. For example, the reflected signal is a result of reflections and/or backscattering from FBGs, Rayleigh scattering, Raman scattering, and/or Brillouin scattering.

Because the frequency of the modulation is swept (i.e., changed), the input light and the resulting reflected signals are formed from wave inputs and, thus, can be considered to be in an optical frequency domain. In general, the amplitude and phase of the resultant signals are measured as a function of the modulation frequency.

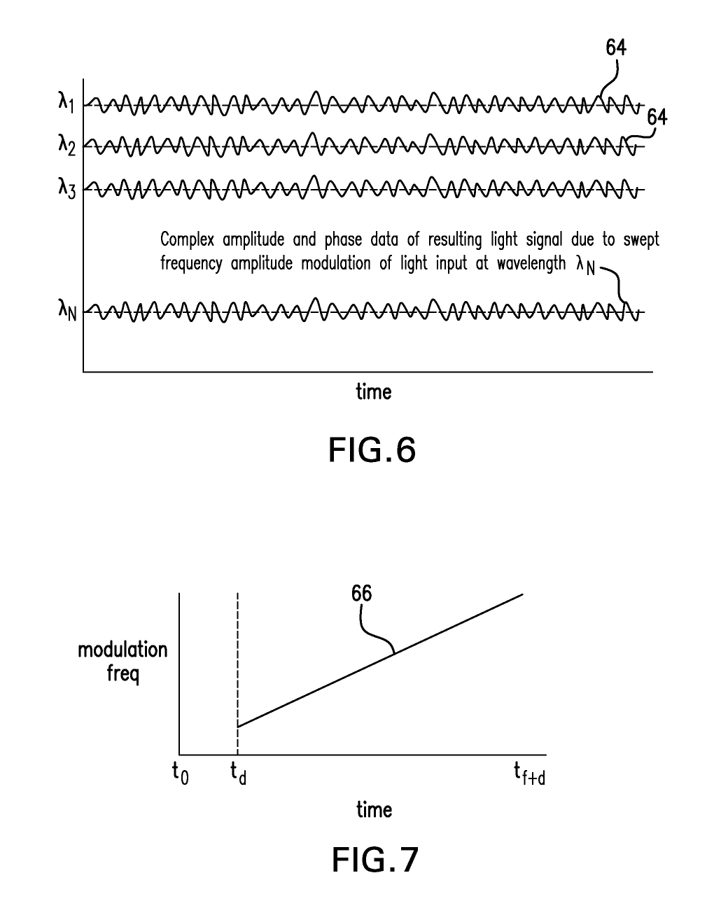

Examples of reflected signal data for a varied modulation frequency are shown in FIG. 6, which depicts aspects of reflected signals 64 due to illumination of the optical fiber by the modulated optical signal, such as the optical signal 62. Each resultant light signal 64 is associated with a light input having a unique optical wavelength λ_{N}. Each of the resultant light signals 64 includes complex amplitude and phase data. The horizontal axis can be considered as a time axis or modulation frequency axis.

In the fourth stage 54, the reflected signal is mixed or demodulated with respect to a reference signal. In one embodiment, the reference signal is the same as or similar to the modulation signal used to modulate the optical signal launched into the fiber. The reference modulation signal is delayed to compensate for some lead-in length. The amount of the delay corresponds to, for example, the time-of-flight of an optical signal between a launching location (e.g., input location of the optical source 24) and a selected location in the optical fiber 22, such as a location of the sensing region 32. The time of flight may be acquired or calculated by any suitable means. For example, the time of flight can be estimated using the measurement unit 20 or other optical source to send a pulsed signal and record the time of receipt of resulting reflected signals.

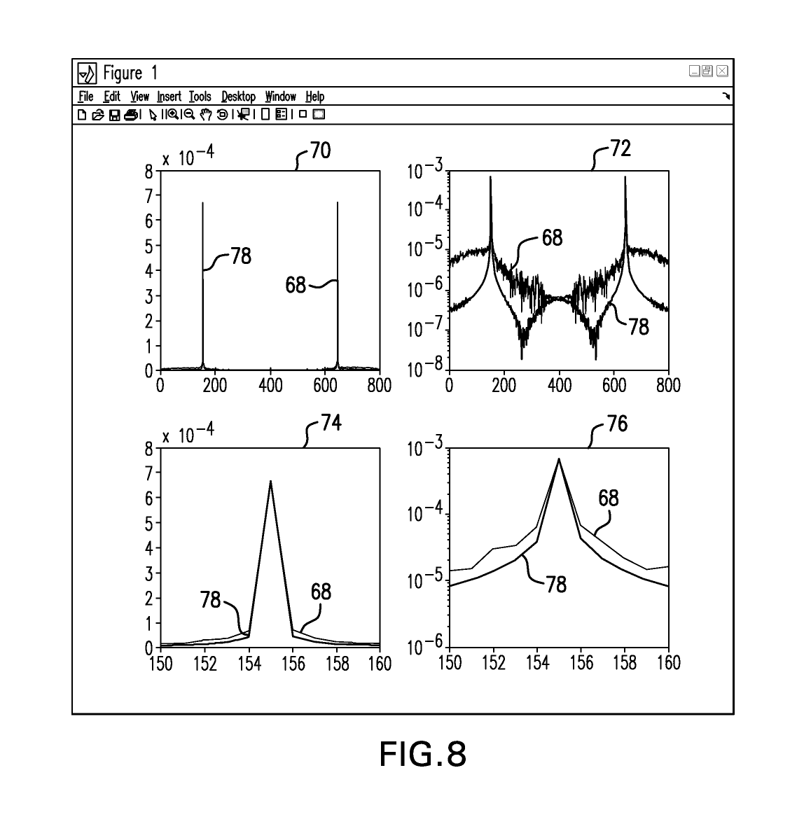

An example of a reference signal includes a reference modulation signal 66 as illustrated in FIG. 7. In this example, the reference modulation signal 66 has at least substantially the same form as the modulation signal 60, 62, i.e., is a sinusoidal waveform having a modulation frequency that is varied over time. A time delay, represented by the time period from t₀ to “t_{d}”, is introduced to the reference modulation signal, and thus the reference modulation signal 66 has a frequency change from t₀ to “t_{f+d}”, which is illustrated in the frequency function shown in FIG. 7. The reference signal can be delayed by any suitable method or mechanism, such as by generating the delayed reference signal by the modulator 34 or a separate signal generation circuit. Other methods of introducing the delay include using digital delay devices such as first-in first-out (FIFO) buffers.

In one embodiment, the reflected signal (e.g., reflected signal 64) is demodulated or mixed, e.g., by measuring the amplitude and/or phase of the reflected signal with respect to the delayed reference signal (e.g. delayed reference signal 66). The demodulation is performed over the time period of the modulated optical signal, e.g., t₀ to t_{f}. This demodulation or mixing operation can be performed by any suitable electronic mixing device, such as a scalar network analyzer for measuring amplitude or a vector network analyzer for measuring amplitude and phase.

The demodulated reflected signal may then be inversely transformed using a mathematical algorithm such as a Fast Fourier Transform (FFT) into a spatial frequency domain. The amplitude of the resultant light (e.g., reflected light) at one spatial time is related to the information being transmitted by the component at the spatial location associated with that one spatial time. A first set of readings or measurements is formed from the reflections (or resulting signals) of the input light at the constant first optical wavelength.

Stages 51-54 may be repeated for optical signals having multiple optical wavelengths. For example, the optical frequency of the input light is changed to a substantially constant second wavelength with the amplitude also being modulated similar to the modulation of the input light at the first frequency. Subsequent sets of readings using additional wavelengths may be performed as desired. The multiple sets of readings may be assembled into one composite set of readings, which provides a complex data set containing, among other parameters, amplitude of reflection (or transmission) and spatial location data for each of the components in optical communication with the optical fiber 22.

In the fifth stage 55, the reflected signal data is utilized to estimate various parameters along the optical fiber 22, such as along the sensing region 32. The reflected signal data is correlated to locations of sensing regions 30, and parameters are estimated for one or more sensing locations 30. Examples of such parameters include temperature, pressure, vibration, strain and deformation of downhole components, chemical composition of downhole fluids or the formation, acoustic events, and others.

FIG. 8 illustrates an example of reflected signal data 68 generated by an OFDR operation performed via the method 50. In this example, an optical fiber is utilized having an effective core refractive index of 1.480 and includes an array of FBGs as sensing locations. A continuous wave laser signal was launched into the fiber and modulated with a modulation signal having a modulation frequency that was swept gradually from about 0.5 MHz to about 25.5 MHz. Plots 70, 72, 74 and 76 show amplitude signals 68 of the mixed reflected signals with respect to fiber length, and also show corresponding signals 78 generated by a model. The plots 70 and 74 are shown in a linear scale and the plots 72 and 76 are shown in a logarithmic scale. Plots 74 and 76 are magnifications of the plots 70 and 72, respectively around the left hand peak. As shown in FIG. 8, the experimental results shown by signal data 68 correlates well with modeled data.

The systems and methods described herein provide various advantages over prior art techniques. The systems and methods provide a mechanism for compensating for or reducing/nullifying the effects of lead-in lengths in reflectometry systems. Arbitrarily long fiber lead-ins (and corresponding demodulation signal delays) can be introduced to an incoherent optical frequency domain reflectometry system, without impacting the effective measurement range of the system. In addition, the introduced delays can be changed in real-time. This leads to significant configurability for an instrument, which has great utility when the lead-in is unknown at the time of the construction of the instrument, and also allows for reducing manufacturing complexity by reducing customizable options. Another advantage is provided by the ability to maximize the effective measurement length of a measurement system. Reducing the effects of lead-in length can also permit avoidance of interrogator marinization, and/or allow interrogators to be positioned away from safety-critical or environmentally challenging environments.

The optical fiber 22 and/or the measurement system are not limited to the embodiments described herein, and may be disposed with any suitable carrier. The measurement system, optical fiber sensor 22, the borehole string 14 and/or the tool 18 may be embodied with any suitable carrier. A “carrier” as described herein means any device, device component, combination of devices, media and/or member that may be used to convey, house, support or otherwise facilitate the use of another device, device component, combination of devices, media and/or member. Exemplary non-limiting carriers include drill strings of the coiled tube type, of the jointed pipe type and any combination or portion thereof. Other carrier examples include casing pipes, wirelines, wireline sondes, slickline sondes, drop shots, downhole subs, bottom-hole assemblies, and drill strings.

In support of the teachings herein, various analysis components may be used, including a digital and/or an analog system. Components of the system, such as the measurement unit 20, the processor 28 and other components of the system 10, may have components such as a processor, storage media, memory, input, output, communications link, user interfaces, software programs, signal processors (digital or analog) and other such components (such as resistors, capacitors, inductors and others) to provide for operation and analyses of the apparatus and methods disclosed herein in any of several manners well appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply (e.g., at least one of a generator, a remote supply and a battery), cooling unit, heating unit, motive force (such as a translational force, propulsional force or a rotational force), magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

It will be recognized that the various components or technologies may provide certain necessary or beneficial functionality or features. Accordingly, these functions and features as may be needed in support of the appended claims and variations thereof are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for estimating a parameter, the method comprising:
generating an optical signal, the optical signal modulated via a modulation signal having a variable modulation frequency over a period of time;
transmitting the modulated optical signal from a light source into an optical fiber, the optical fiber including at least one sensing location configured to reflect light;
receiving a reflected signal including light reflected from the at least one sensing location; and
demodulating the reflected signal with a reference signal, the reference signal including a time delay relative to the modulation signal based on a distance between the light source and the at least one sensing location.

2. The method of claim 1, wherein the optical signal is modulated with a modulation frequency that is varied between an initial time and a final time.

3. The method of claim 2, wherein the reference signal has a modulation frequency that is varied between a delayed initial time and the final time, the delayed initial time occurring after the initial time.

4. The method of claim 3, wherein the reflected signal is demodulated with the reference signal over a time period between the initial time and the final time.

5. The method of claim 1, wherein the modulation frequency is varied between an initial frequency and a maximum frequency in a linear manner.

6. The method of claim 1, wherein the modulation frequency is varied between an initial frequency and a maximum frequency in one of a continuous manner and a step-wise manner.

7. The method of claim 1, wherein the reference signal has at least substantially the same form as the modulation signal, the form being temporally delayed according to the time delay.

8. The method of claim 1, further comprising transforming the demodulated reflected signal from a frequency domain into a spatial frequency domain to provide a measurement set corresponding to a length of the optical fiber.

9. The method of claim 1, wherein transforming includes applying a Fast Fourier Transform to the demodulated reflected signal.

10. The method of claim 1, wherein the optical signal is at least one of amplitude modulated and intensity modulated.

11. The method of claim 1, further comprising estimating a parameter of the optical fiber based on the demodulated reflected signal.

12. The method of claim 11, wherein the parameter includes at least one of pressure, temperature, strain, force, acceleration, shape, and an optical response of the optical fiber.

13. A system for estimating a parameter, the system comprising:
a light source in optical communication with an optical fiber, the optical fiber including at least one sensing location configured to reflect light;
a modulator configured to modulate the optical signal via a modulation signal having a variable modulation frequency over a period of time;
a detector configured to receive a reflected signal including light reflected from the at least one sensing location; and
a processor configured to demodulate the reflected signal with a reference signal, the reference signal including a time delay based on a distance between the light source and the at least one sensing location.

14. The system of claim 13, wherein the modulation frequency is varied between an initial frequency and a maximum frequency in a linear manner.

15. The system of claim 13, wherein the processor is further configured to transform the demodulated reflected signal from a frequency domain into a spatial frequency domain to provide a measurement set corresponding to a length of the optical fiber.

16. The system of claim 13, wherein the light source includes a wavelength tunable continuous wave light source.

17. The system of claim 13, wherein the optical fiber is configured to be disposed in a borehole penetrating the earth.

18. A computer-readable medium comprising computer-executable instructions for estimating a parameter by implementing a method comprising:
generating an optical signal, the optical signal modulated via a modulation signal having a variable modulation frequency over a period of time;
transmitting the modulated optical signal from a light source into an optical fiber, the optical fiber including at least one sensing location configured to reflect light;
receiving a reflected signal including light reflected from the at least one sensing location; and
demodulating the reflected signal with a reference signal, the reference signal including a time delay relative to the modulation signal based on a distance between the light source and the at least one sensing location.

19. The computer-readable medium of claim 18, wherein the optical signal is modulated with a modulation frequency that is varied between an initial time and a final time, and the reference signal has a modulation frequency that is varied between a delayed initial time and the final time, the delayed initial time occurring after the initial time.

20. The computer-readable medium of claim 19, wherein the reflected signal is demodulated with the reference signal over a time period between the initial time and the final time.
